(19) United States
(12) Patent Application Publication
(10) Pub. No.: US 2012/0229066 A1
(43) Pub. Date: Sep. 13, 2012

(54) VARIABLE FIELD MAGNET ROTATING ELECTRICAL MACHINE

(75) Inventor: Tuyoshi Nonaka, Fukuoka (JP)

(73) Assignee: KABUSHIKI KAISHA YASKAWA DENKI, Kitakyushu-shi (JP)

(21) Appl. No.: 13/364,323

(22) Filed: Feb. 2, 2012

(30) Foreign Application Priority Data
Mar. 9, 2011 (JP) 2011-051027

(51) Int. Cl. H02P 25/02; H02K 11/00; H02K 21/12

(52) U.S. Cl. 318/400.41; 310/156.05; 310/68 B

(57) ABSTRACT

A variable field magnet rotating electrical machine includes a stator, a rotor, and a rotary position detector. The stator includes a stator winding coil and a stator iron core. The rotor includes a field magnet, a first field magnetic pole portion, and a second field magnetic pole portion. The first field magnetic pole portion is configured to turn relative to the second field magnetic pole portion. The first and second field magnetic pole portions include signal generators each configured to generate a signal to detect a rotary position of a corresponding one of the first and second field magnetic pole portions. The rotary position detector is configured to detect a rotary position of the rotor.

### CROSS-REFERENCE TO RELATED APPLICATIONS

The present application claims priority under 35 U.S.C.§119 to Japanese Patent Application No. 2011-051027, filed Mar. 9, 2011. The contents of this application are incorporated herein by reference in their entirety.

### BACKGROUND OF THE INVENTION

1. Field of the Invention

The present invention relates to a variable field magnet rotating electrical machine.

2. Discussion of the Background

As disclosed in Japanese Unexamined Patent Application Publication No. 2010-074975, a conventional variable field magnet rotating electrical machine includes an embedded magnet rotor with a magnetic pole unit axially divided into three portions. The three portions turn relative to each other to make the magnitude of the field magnet variable.

The conventional variable field magnet rotating electrical machine is shown in FIG. 1 of the JP2010-074975 publication. The magnetic pole unit is axially divided into three portions, namely, side magnetic pole portions secured to a shaft, and an intermediate magnetic pole portion between the side magnetic pole portions. The intermediate magnetic pole portion turns relative to the side magnetic pole portions. Each of the magnetic pole portions includes permanent magnets.

The variable magnitude of the field magnet is controlled by a hydraulic controller disposed at the bearing in the anti-load side bracket. The hydraulic controller supplies hydraulic pressure to a hydraulic mechanism disposed in the rotating rotor, thus making the magnitude of the field magnet variable.

Thus, the variable field magnet rotating electrical machine varies the magnitude of the field magnet of the rotor to ensure an enlarged variable speed range and a highly efficient operation.

### SUMMARY OF THE INVENTION

According to one aspect of the present invention, a variable field magnet rotating electrical machine includes a stator, a rotor, and a rotary position detector. The stator includes a stator winding coil and a stator iron core. The rotor includes a field magnet, a first field magnetic pole portion, and a second field magnetic pole portion. The first field magnetic pole portion is configured to turn relative to the second field magnetic pole portion. The first and second field magnetic pole portions include signal generators each configured to generate a signal to detect a rotary position of a corresponding one of the first and second field magnetic pole portions. The rotary position detector is configured to detect a rotary position of the rotor.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view in the axial direction of a variable field magnet rotating electrical machine according to a first embodiment of the present invention;

FIG. 2 is a cross-sectional view in the radial direction of the variable field magnet rotating electrical machine on an intermediate field magnetic pole portion according to the first embodiment;

FIG. 3 is an exploded perspective view of the rotor illustrating its configuration;

FIGS. 4A and 4B are cross-sectional views in the radial direction of two, stationary and movable field magnetic pole portions illustrating a configuration of their relative turn by hydraulic control;

FIGS. 5A and 5B are perspective views of the field magnetic pole portions illustrating positional relationships of the magnetic poles;

FIG. 6 is a graph of a relative angle between the two, stationary and movable field magnetic pole portions versus the magnitude of the field magnet;

FIG. 7 is a graph illustrating, on the time axis, changes in an output signal Ss of a Hall element obtained from a stationary sensor magnet and in an output signal Sm of a Hall element obtained from a movable sensor magnet;

FIGS. 8A and 8B are tables of measurement examples of a control value map of the variable field magnet rotating electrical machine at the time of maximum efficiency vector control according to the first embodiment; and

FIG. 9 illustrates map control to reproduce maximum efficiency vector control.

### DESCRIPTION OF THE EMBODIMENTS

The embodiments will now be described with reference to the accompanying drawings, wherein like reference numerals designate corresponding or identical elements throughout the various drawings.

### First Embodiment

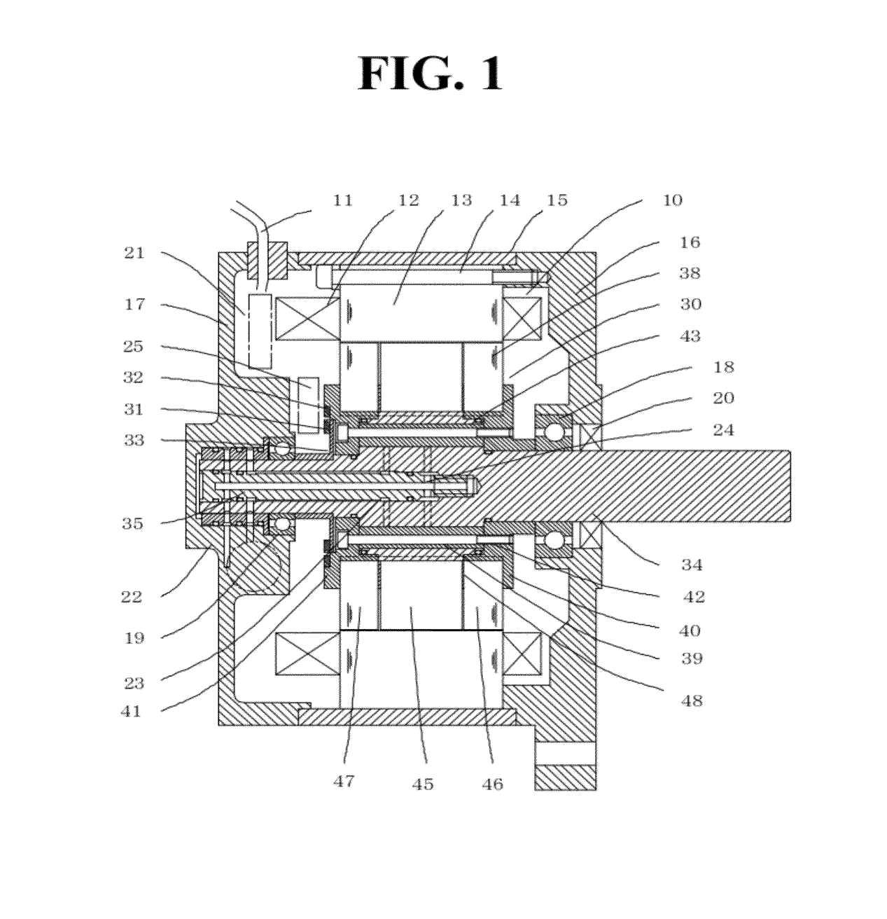

First, by referring to FIG. 1, a variable field magnet rotating electrical machine according to the first embodiment will be described below. FIG. 1 is a cross-sectional view in the axial direction of the variable field magnet rotating electrical machine according to the first embodiment of the present invention, intended to be used for an electric motor of vehicle driving or for an electric generator.

As shown in FIG. 1, the variable field magnet rotating electrical machine according to the first embodiment includes a stator 10, a rotor 30, and a rotary position detector 25 for the rotor. The stator 10 includes a stator winding coil 12 and a stator iron core 13. The rotor 30 includes field magnets.

Current to the stator winding coil 12 is carried through a lead wire 11. The stator iron core 13 is secured to a load side bracket 16 with a stator securing bolt 14. An anti-load side bracket 17 along with a frame 15 is secured to the load side bracket 16 with bolts, not shown.

The rotor 30 is rotatably coupled to the load side bracket 16 and the anti-load side bracket 17 via a load side bearing 18 and an anti-load side bearing 19, which are secured to a rotor shaft 34. The rotary position of the rotor 30 is detected by the rotary position detector 25, which is mounted to the anti-load side bracket 17.

The rotor 30 includes three field magnetic pole portions aligned in the axial direction. Namely, an intermediate field magnetic pole portion 45 is secured to the rotor shaft 34, and a load side field magnetic pole portion 46 and an anti-load side field magnetic pole portion 47 turn relative to the intermediate field magnetic pole portion 45 by hydraulic pressure.

A hydraulic controller 22 is disposed at the anti-load side bracket 17 and the anti-load side bearing 19. The hydraulic controller 22 supplies hydraulic pressure to a hydraulic chamber between a load side plate 40 and an anti-load side plate 41. The hydraulic pressure is supplied through a magnetizing hydraulic inlet 23 and a demagnetizing hydraulic inlet 24, which are defined by a cylindrical part 35 of the rotor shaft 34. The hydraulic controller 22 controls the hydraulic pressure to cause circumferential movement of a pressure receiving plate 39, which is coupled to a load side plate 40 and an anti-load side plate 41 with a bolt 42. This causes the side field magnetic pole portions 46 and 47 to turn relative to the intermediate field magnetic pole portion 45, thus making the magnitude of the field magnet variable.

The oil used for the control is partially used for the lubrication of the bearings. A load side oil seal 20 eliminates or minimizes outflow of oil. O-rings 43 eliminate or minimize leakage of oil out of the hydraulic chamber. Thrust washers 48 keep the intermediate field magnetic pole portion 45 out of contact with the side field magnetic pole portions 46 and 47.

Rotary position signals for the rotary position detector 25 are generated at a stationary sensor magnet 31 and a movable sensor magnet 32, which are permanent magnets. The stationary sensor magnet 31 and the movable sensor magnet 32 each have alternating north poles and south poles that are the same in number as the number of north poles and south poles of each of the field magnetic pole portions.

The stationary sensor magnet 31 is a signal generator to detect the rotary position of the intermediate field magnetic pole portion 45 secured to the rotor shaft 34, and is disposed on a sensor magnet stay 33, which is secured to the rotor shaft 34. The movable sensor magnet 32 is a signal generator to detect the rotary position of the side field magnetic pole portions 46 and/or 47, which are configured to turn. The movable sensor magnet 32 abuts on the outer circumferential side of the stationary sensor magnet 31 on a side of the anti-load side field magnetic pole portion 47.

The rotary position detector 25 includes two Hall elements as signal detectors to detect the rotary positions of two field magnetic pole portions, among which one is on the stationary side and the other is on the turning side. The two Hall elements are disposed opposite the stationary sensor magnet 31 and the movable sensor magnet 32. The rotary position detector 25 includes a simple electric circuit to output sinusoidal signals indicating the rotary positions of the two, stationary and movable field magnetic pole portions.

In the first embodiment, the side magnetic poles turn relative to the intermediate magnetic pole. This facilitates provision of a signal generator individually to each of the two, stationary and movable field magnetic pole portions, among which the movable field magnetic pole portion turns relative to the stationary field magnetic pole portion, so as to detect the rotary positions of the respective field magnetic pole portions.

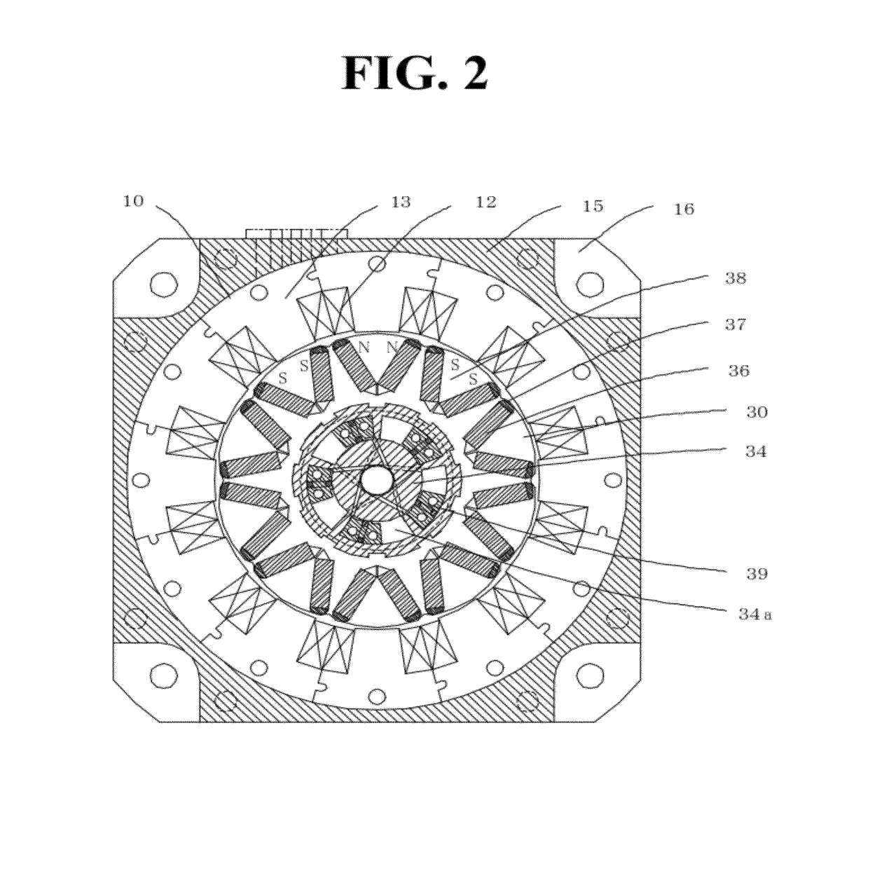

FIG. 2 is a cross-sectional view in the radial direction of the variable field magnet rotating electrical machine on the intermediate field magnetic pole portion according to the first embodiment.

As shown in FIG. 2, the stator 10 includes twelve separate stator iron cores 13. Each of the stator iron cores 13 includes a stator winding coil 12 that is an air core coil.

Each of the three field magnetic pole portions aligned in the axial direction includes a rotor iron core 38, approximately V-shaped permanent magnet mounting holes disposed in the rotor iron core 38, and permanent magnets 36 disposed in the respective permanent magnet mounting holes along with resin members 37 adjacent the outer portions in the radial direction of the respective permanent magnets 36. The permanent magnets 36 have facing or reverse magnetized directions, thus forming ten magnetic poles.

The intermediate field magnetic pole portion is secured to the circumference of the rotor shaft 34. The shaft 34 includes hydraulic chambers 34a. The side field magnetic pole portions are integrally secured to the movable pressure receiving plates 39, which are disposed in the hydraulic chamber 34a. This ensures that a supply of hydraulic pressure into the hydraulic chamber 34a causes circumferential movement of the pressure receiving plate 39, and this causes the side magnetic poles to turn relative to the intermediate magnetic pole.

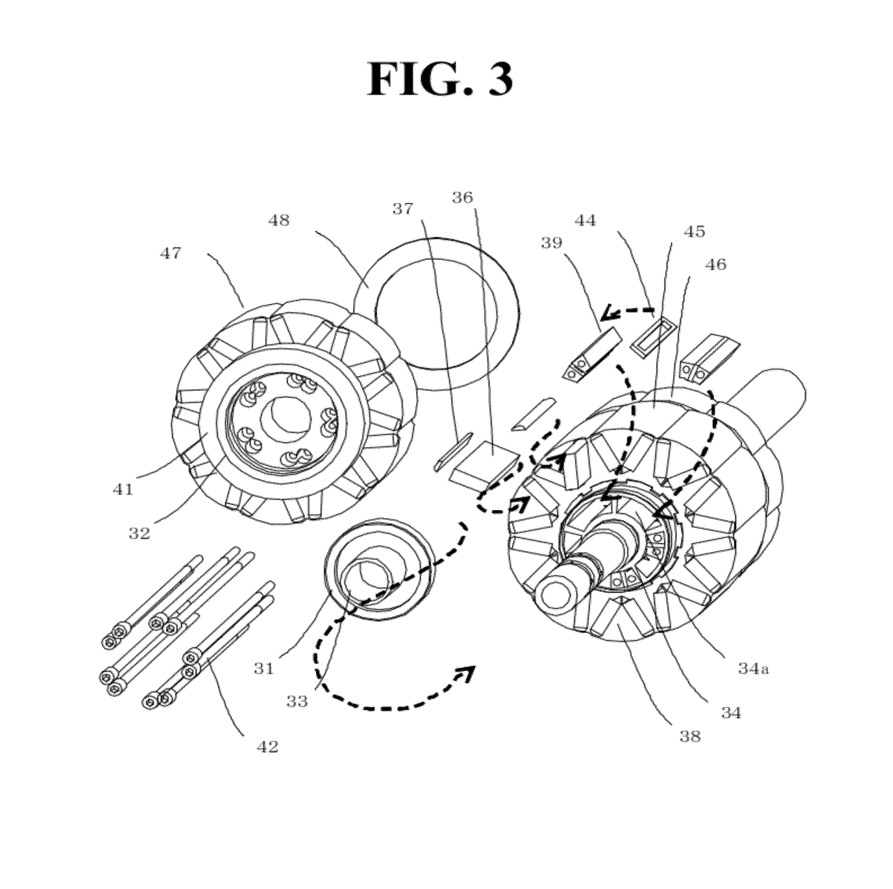

FIG. 3 is an exploded perspective view of the rotor illustrating its configuration.

As shown in FIG. 3, the intermediate field magnetic pole portion 45 is secured to the rotor shaft 34 on the rotor iron core 38.

The pressure receiving plates 39 disposed in the hydraulic chambers 34a of the rotor shaft 34, the load side movable magnetic pole portion 46, and the anti-load side movable magnetic pole portion 47 are integrally secured to each other with ten bolts 42. The pressure receiving plates 39 each has an oil seal 44, which serves to seal oil.

The movable sensor magnet 32, which serves as a signal generator to detect the rotary position of a movable magnetic pole, is disposed on the anti-load side movable magnetic pole portion 47. The stationary sensor magnet 31, which detects the rotary position of the stationary magnetic pole, is disposed on the rotor shaft 34 via the sensor magnet stay 33.

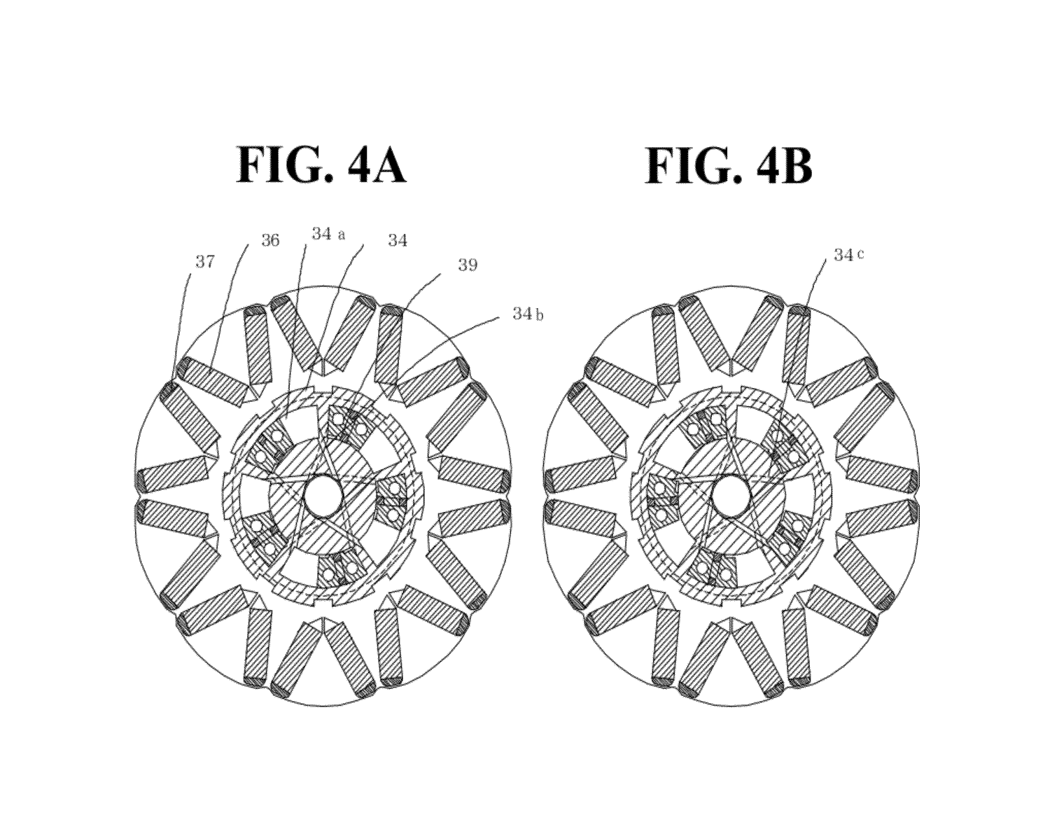

FIGS. 4A and 4B are cross-sectional views in the radial direction of the two, stationary and movable field magnetic pole portions illustrating a configuration of their relative turn by hydraulic control.

As shown in FIG. 4A, when the field magnet is intended to be demagnetized, high pressure oil is introduced into the hydraulic chambers 34a through demagnetizing hydraulic inlet holes 34b so as to move the pressure receiving plates 39 in the counterclockwise, circumferential direction, thereby increasing the relative angle between the two, stationary and movable field magnetic pole portions.

As shown in FIG. 4B, when the field magnet is intended to be magnetized, high pressure oil is introduced into the hydraulic chambers 34a through magnetizing hydraulic inlet holes 34c so as to move the pressure receiving plates 39 in the clockwise, circumferential direction, thereby decreasing the relative angle between the two, stationary and movable field magnetic pole portions.

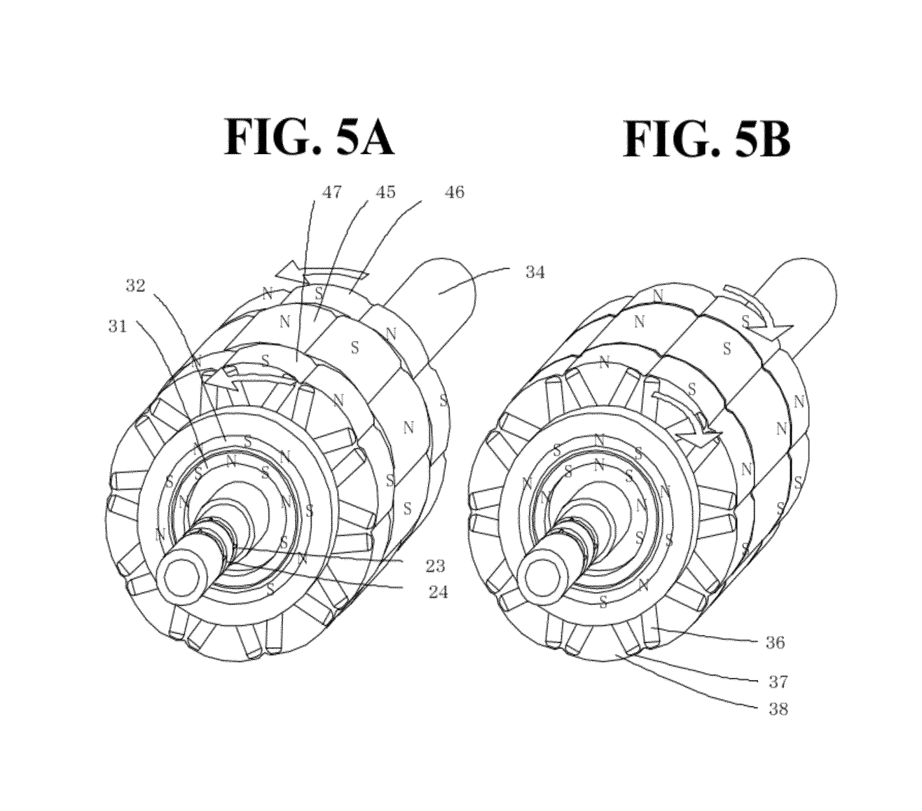

FIGS. 5A and 5B are perspective views of the field magnetic pole portions illustrating positional relationships of the magnetic poles in the states shown in FIGS. 4A and 4B.

In the demagnetized state shown in FIG. 5A, the load side field magnetic pole portion 46 and the anti-load side field magnetic pole portion 47 make a large turn relative to the intermediate field magnetic pole portion 45. In this state, the magnetic poles cancel out each other out, resulting in a diminished field magnet linked with the stator winding coil. The position of the field magnet is equivalent to approximately the center between the north pole of the intermediate field magnetic pole portion 45 and the north poles of the side intermediate field magnetic pole portions 46 and 47. The magnitude of the north pole of the field magnet is equivalent to the inner product of the relative electric angle between the two, stationary and movable field magnetic pole portions. A similar way of thinking applies to the south pole.

In the magnetized state shown in FIG. 5B, the load side field magnetic pole portion 46 and the anti-load side field magnetic pole portion 47 have their magnetic poles aligned with the corresponding magnetic poles of the intermediate field magnetic pole portion 45, resulting in the maximum field magnet.

The stationary sensor magnet 31 and the movable sensor magnet 32 are permanent magnets each having alternating north poles and south poles that are the same in number as the number of the north poles and south poles of each of the field magnetic pole portions.

The stationary sensor magnet 31 has its magnetic poles aligned with those of the intermediate field magnetic pole portion 45. The movable sensor magnet 32 has its magnetic poles aligned with those of the side field magnetic pole portions 46 and 47. This ensures that detecting a magnetic pole of the stationary sensor magnet 31 results in detection of the position of the corresponding magnetic pole of the intermediate field magnetic pole portion 45, and that detecting a magnetic pole of the movable sensor magnet 32 results in detection of the position of the corresponding magnetic pole of the side field magnetic pole portion 46 and/or 47.

Turning the side field magnetic pole portions 46 and 47 in the rotating direction of the rotor decreases the relative angle between the two, stationary and movable field magnetic pole portions. The maximum efficiency vector control of a variable field magnet rotating electrical machine intended to be used for an electric motor of vehicle or for an electric generator requires increasing the relative angle in small torque command state, and decreasing the relative angle in large torque command state, as described later.

For example, assume that the rotor of the electric rotating electrical machine for vehicle driving shown in FIGS. 5A and 5B rotates in the clockwise direction in a motor structure. In a small torque command state with approximately no load, attraction occurs between the north poles and the south poles of the two, stationary and movable field magnetic pole portions. This results in an approximately large state of the relative angle between the two, stationary and movable field magnetic pole portions shown in FIG. 5A without hydraulic pressure. In a large torque command state requiring some acceleration, the side field magnetic pole portions, which are configured to turn, are attracted to the rotative electromagnetic force of the stator. This reduces the necessary hydraulic pressure by the degree equivalent to the attraction, and results in a small state of the relative angle between the two, stationary and movable field magnetic pole portions shown in FIG. 5B.

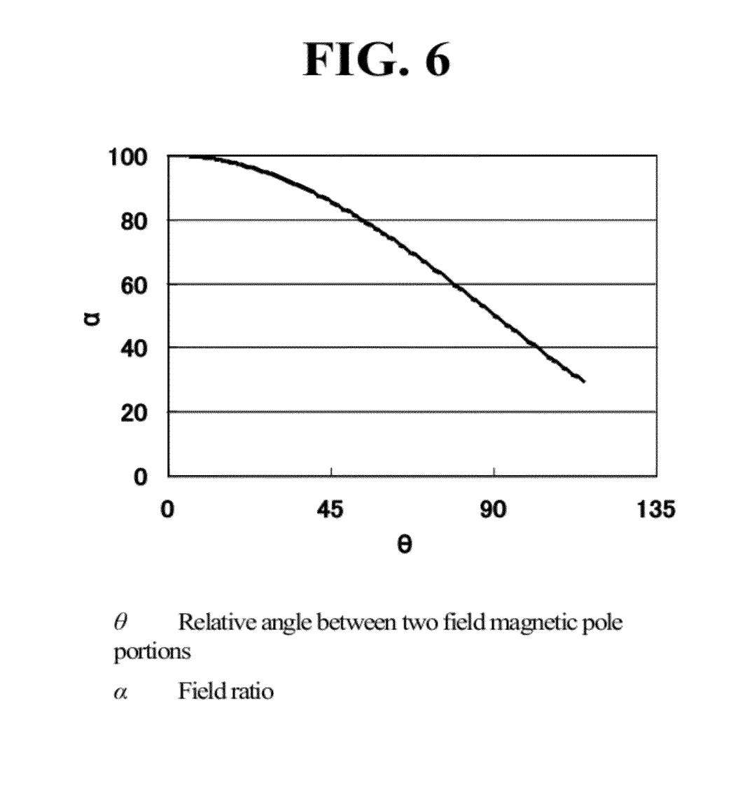

FIG. 6 is a graph of a relative angle between the two, stationary and movable field magnetic pole portions versus the magnitude of the field magnet.

Assume that an induced voltage constant is 100% when the field magnet is at its maximum, which is when the two, stationary and movable field magnetic pole portions are aligned with one another. Also assume that a field ratio a is a percentage of an induced voltage constant relative to the 100% induced voltage constant at the time when the movable field magnetic pole portion of the two, stationary and movable field magnetic pole portions turns relative to the stationary field magnetic pole portion. FIG. 6 shows a characteristic of the field ratio α relative to the relative angle θ of the two, stationary and movable field magnetic pole portions. Specifically, the field ratio α varies from 100% to 30% as the relative angle θ between the two, stationary and movable field magnetic pole portions varies from 0 to 120 degrees.

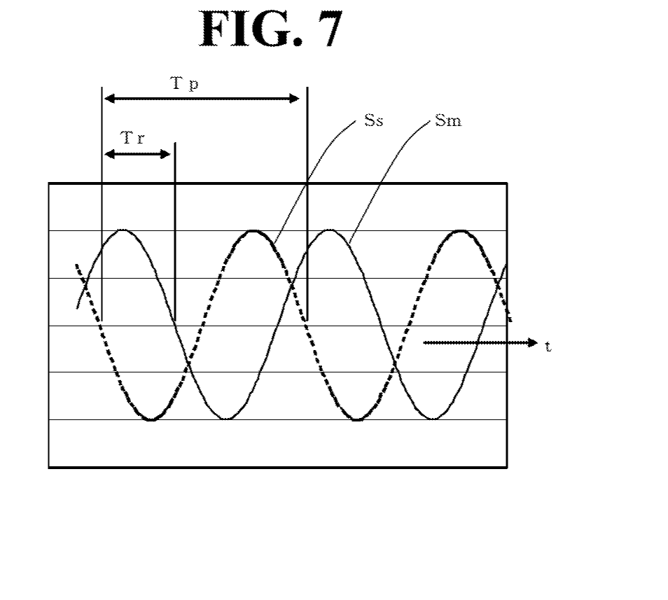

FIG. 7 is a graph illustrating, on the time axis, changes in an output signal Ss of a Hall element obtained from the stationary sensor magnet and in an output signal Sm of a Hall element obtained from the movable sensor magnet.

As shown in FIG. 7, the two output signals are accurate sinusoidal signals, which are ensured by adjusting, for example, the positions of the sensor magnets. This ensures detection of the current rotary positions of the two, stationary and movable field magnetic pole portions based on the magnitude of the signals detected by the rotary position detectors.

The rotation rate is calculated from a signal period Tp. The relative angle between the two, stationary and movable field magnetic pole portions in motion is calculated from a ratio of a delay time Tr to the signal period Tp. The delay time Tr is a delay of the output signal of the Hall element obtained from the stationary sensor magnet relative to the output signal of the Hall element obtained from the movable sensor magnet.

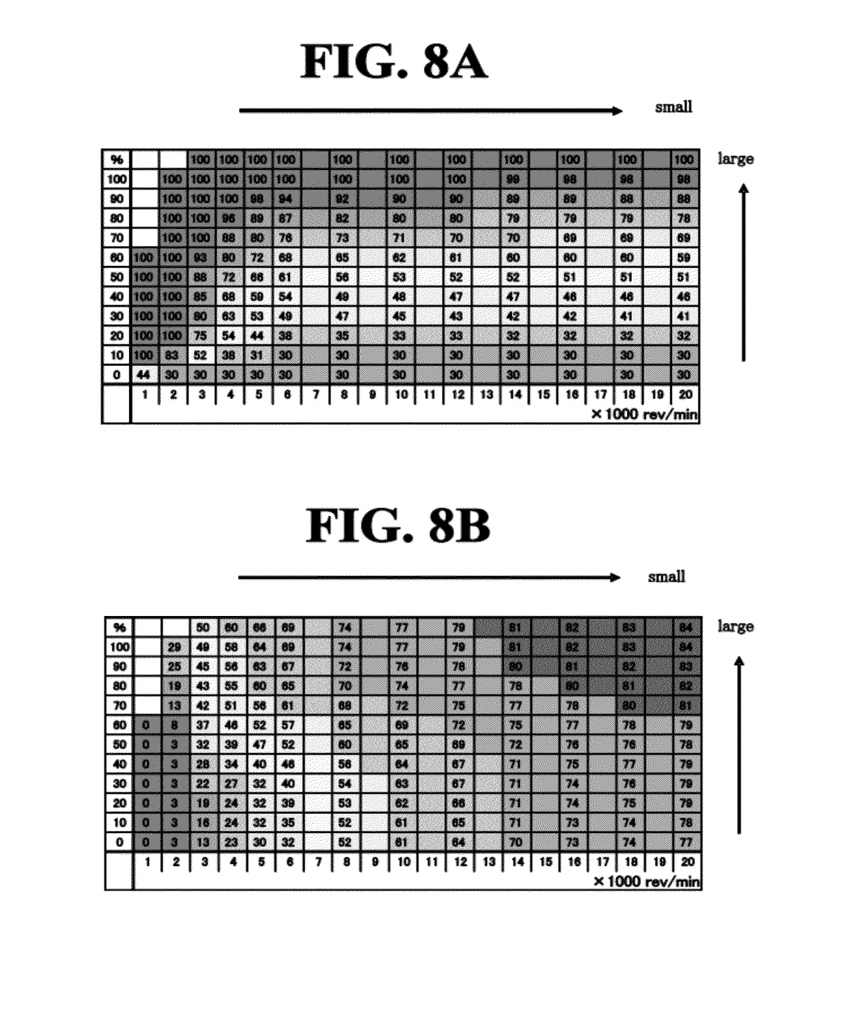

FIGS. 8A and 8B are tables of measurement examples of a control value map of the variable field magnet rotating electrical machine at the time of maximum efficiency vector control according to the first embodiment.

In FIGS. 8A and 8B, the rotation rate is on the horizontal axis and the output ratio is on the vertical axis. FIG. 8A shows the field ratio. FIG. 8B shows the load angle of a three-phase current through the stator winding coil relative to the magnetic pole position collaboratively formed by the two, stationary and movable field magnetic pole portions. As the load angle increases, the rotary electromagnetic force from the stator against the magnetic poles of the rotor advances in angle, thus increasing the field weakening force.

As shown in FIG. 8, at 16000 rev/min and 70% output, for example, the relative angle between the two, stationary and movable field magnetic pole portions are adjusted to set the field ratio at 69%, and current is supplied at a load angle of 78 degrees. These ensure the maximum efficiency of the electric rotating electrical machine of the first embodiment.

The maps reveal the following details. In order to maximize the efficiency of the variable field magnet rotating electrical machine, the field ratio is controlled at a lower level as the rotation rate increases and as the output ratio decreases, while the load angle is controlled at a higher level as the rotation rate increases and as the output ratio increases.

In order to improve the power consumption of the variable field magnet rotating electrical machine for vehicle driving over the conventional machines, it is important to operate the electric rotating electrical machine at its maximum efficiency. In view of this, target values of the field ratio, the load angle, and the current are reproduced by map control.

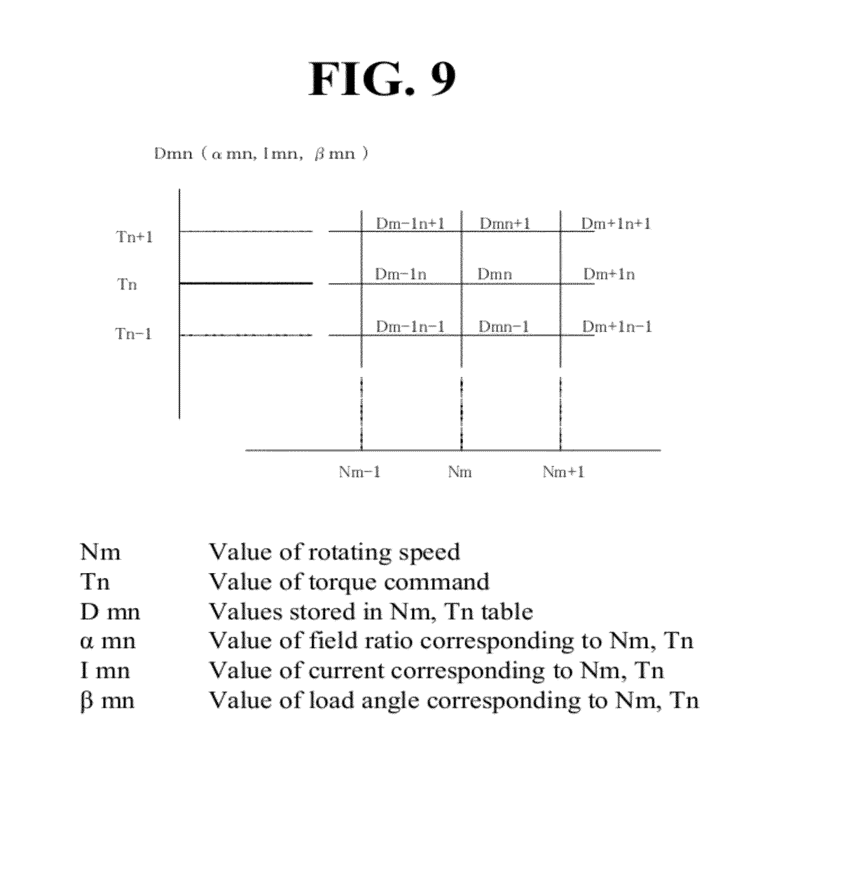

FIG. 9 illustrates map control to reproduce maximum efficiency vector control.

In actual control of the variable field magnet rotating electrical machine for vehicle driving, the map control is executed using a torque command as a replacement of the output for convenience. The degree of depression of the accelerator pedal corresponds to the magnitude of the torque command. The rotation rate N of the electric rotating electrical machine and the torque command T are used to read the field ratio α, the load angle β, and the current I, which are assumed target values. Feedback control is executed to keep the field ratio, the load angle, and the current within predetermined errors relative to the target values.

Specifically, when the rotation rate of the electric rotating electrical machine is between Nm and Nm+1, and the torque command is between Tn and Tn+1, then data are read from Dmn. Dmn stores three kinds of data, namely, the field ratio α mn, the load angle β mn, and the current I mn. When the rotation rate drops to between Nm−1 and Nm, then data are read from Dm−1n. The data for control are prepared for all of the rotation rates and the torque commands associated with the operation of the electric rotating electrical machine.

Among the field ratio, the load angle, and the current, the maximum efficient control requires fine control of the load angle and the current. Although the field ratio may be controlled in approximate terms, the current value of the field ratio needs to be precisely detected along with the rotation rate and the torque command. The current value of the field ratio is obtained by detecting the relative turn angle between two magnetic poles.

Thus, the variable field magnet rotating electrical machine according to the first embodiment includes a signal generator individually to each of the two, stationary and movable field magnetic pole portions, among which the movable field magnetic pole portion turns relative to the stationary field magnetic pole portion, so as to detect the rotary positions of the respective field magnetic pole portions. This ensures accurate detection of the relative angle between the two, stationary and movable field magnetic pole portions. This ensures a wide range of operation with high efficiency, and improves the electric power consumption of the variable field magnet rotating electrical machine for vehicle driving over the conventional machines.

In the first embodiment, the stationary sensor magnet 31 and the movable sensor magnet 32 of permanent magnet are used as signal generators for rotary position detection. It is also possible to use other signal generators such as those utilizing optical transmission and those utilizing changes in magnetic permeability.

The signal generators have been described, by way of example, as being disposed on a side of the anti-load side field magnetic pole portion 47. The two signal generators may also be adjacent one another in the axial direction on the rotor shaft.

The variable field magnet rotating electrical machine according to the embodiments ensures a wide range of operation with high efficiency. Therefore, the variable field magnet rotating electrical machine will find applications in other general industrial applications in addition to vehicle applications, examples including, but not limited to, main shaft applications of machine tools.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A variable field magnet rotating electrical machine comprising:
a stator comprising a stator winding coil and a stator iron core;
a rotor comprising:
a field magnet; and
a first field magnetic pole portion and a second field magnetic pole portion, the first field magnetic pole portion being configured to turn relative to the second field magnetic pole portion, the first and second field magnetic pole portions comprising signal generators each configured to generate a signal to detect a rotary position of a corresponding one of the first and second field magnetic pole portions; and
a rotary position detector configured to detect a rotary position of the rotor.

2. The variable field magnet rotating electrical machine according to claim 1,
wherein the rotor has an axial direction and further comprises a third field magnetic pole portion aligned with the first and second field magnetic pole portions in the axial direction, and
wherein the second field magnetic pole portion is secured to a shaft, and the first and third field magnetic pole portions are disposed on axial sides of the second field magnetic pole portion and are configured to turn relative to the second field magnetic pole portion.

3. The variable field magnet rotating electrical machine according to claim 1, wherein the signal generators each comprise a permanent magnet having alternating north poles and south poles, the north poles and south poles being same in number as a number of north poles and south poles of each of the first and second field magnetic pole portions.

4. The variable field magnet rotating electrical machine according to claim 2,
wherein one signal generator among the signal generators to detect the rotary position of the second field magnetic pole portion is secured to the shaft,
wherein another signal generator among the signal generators to detect the rotary position of at least one of the first and third field magnetic pole portions is secured to at least one of the first and third field magnetic pole portions.

5. The variable field magnet rotating electrical machine according to claim 4, wherein the rotor has a radial direction, and the one signal generator and the other signal generator abut on one another in the radial direction on a side of one of the first and third field magnetic pole portions.

6. The variable field magnet rotating electrical machine according to claim 1, wherein the rotary position detector comprises an electric circuit comprising two Hall elements as signal detectors to detect rotary positions of the first and second field magnetic pole portions.

7. The variable field magnet rotating electrical machine according to claim 1, wherein the rotary position detector is configured to output two signals to detect a relative angle between the first and second field magnetic pole portions.

8. The variable field magnet rotating electrical machine according to claim 1, wherein based on a rotation rate and a torque command, the variable field magnet rotating electrical machine is configured to execute map control to reproduce a target value of a relative angle between the first and second field magnetic pole portions, a target value of a current, and a target value of a load angle.

9. The variable field magnet rotating electrical machine according to claim 8,
wherein the relative angle between the first and second field magnetic pole portions increases as the rotation rate increases and as the torque command decreases, and
wherein the load angle increases as the rotation rate increases and as the torque command increases.

10. The variable field magnet rotating electrical machine according to claim 7, wherein the first and third field magnetic pole portions are configured to turn in a rotating direction of the rotor to decrease the relative angle between the first and second field magnetic pole portions.

11. The variable field magnet rotating electrical machine according to claim 8, wherein the first and third field magnetic pole portions are configured to turn in a rotating direction of the rotor to decrease the relative angle between the first and second field magnetic pole portions.

12. The variable field magnet rotating electrical machine according to claim 9, wherein the first and third field magnetic pole portions are configured to turn in a rotating direction of the rotor to decrease the relative angle between the first and second field magnetic pole portions.
